(19) United States
(12) Patent Application Publication
(10) Pub. No.: US 2016/0097354 A1
(43) Pub. Date: Apr. 7, 2016

(54) INTERNAL COMBUSTION ENGINE HAVING A CRANKCASE VENTILATION DEVICE, AND METHOD FOR MONITORING A CRANKCASE VENTILATION DEVICE

(71) Applicants: Hengst SE & Co. KG, Muenster (DE); Hengst of North America, Inc., Camden, SC (US)

(72) Inventors: Kevin Martus, Howell, MI (US); Dave Pollock, Hartland, MI (US); Martin Roelver, Havixbeck (DE)

(21) Appl. No.: 14/873,411

(22) Filed: Oct. 2, 2015

Related U.S. Application Data
(60) Provisional application No. 62/065,089, filed on Oct. 17, 2014.

(30) Foreign Application Priority Data
Oct. 2, 2014 (DE) 102014114397.3

(51) Int. Cl. F02M 35/10

(52) U.S. Cl. CPC F02M 35/10222; F01M 2013/0083

(57) ABSTRACT

An internal combustion engine having an intake air duct with a compressor, a throttle valve, and a crankcase ventilation device with a ventilation duct connected to a crankcase with a crankcase pressure regulating valve, the ventilation duct divided into a first ventilation duct branch connected to the intake air duct upstream from the compressor, and a second ventilation duct branch connected to the intake air duct downstream from the throttle valve. A pressure difference between the pressure in the crankcase or in the ventilation duct upstream from the crankcase pressure regulating valve on the one hand and the pressure in the ventilation duct downstream from the crankcase pressure regulating valve on the other hand is measured by, for example, a sensor, and an evaluation unit evaluates for a correct or incorrect functioning of the crankcase ventilation device and a corresponding item of information can be outputted.

### RELATED APPLICATIONS

This application claims priority to German Patent Application No. 10 2014 114 397.3, filed on Oct. 2, 2014 and also claims priority to U.S. Provisional Patent Application Ser. No. 62/065,089 filed on Oct. 17, 2014, the entirety of both of which are incorporated herein by reference.

### FIELD OF THE INVENTION

The present invention relates to an internal combustion engine having an intake air duct in the course of which there are situated a compressor of an exhaust gas turbocharger or compressor, and, downstream from the compressor, a throttle valve, and having a crankcase ventilation device that has a ventilation duct connected to the crankcase of the internal combustion engine, in the course of which duct there is situated a crankcase pressure regulating valve, the ventilation duct being divided, downstream from the crankcase pressure regulating valve, into two ventilation duct branches, a first ventilation duct branch being connected to the intake air duct at a connecting point upstream from the compressor, and a second ventilation duct branch being connected to the intake air duct at a connecting point downstream from the throttle valve, and a respective check valve being situated in each ventilation duct branch.

In addition, the present invention relates to a method for monitoring a crankcase ventilation device of an internal combustion engine having an intake air duct in the course of which there are situated a compressor of an exhaust gas turbocharger or compressor, and, downstream from the compressor, a throttle valve, the crankcase ventilation device having a ventilating duct connected to the crankcase of the internal combustion engine, in the course of which duct there is situated a crankcase pressure regulating valve, the ventilation duct being divided, downstream from the crankcase pressure regulating valve, into two ventilation duct branches, a first ventilation duct branch being connected to the intake air duct at a connecting point upstream from the compressor, and a second ventilation duct branch being connected to the intake air duct at a connecting point downstream from the throttle valve, and a respective check valve being situated in each ventilation duct branch.

### BACKGROUND OF THE INVENTION

From DE 102 49 720 A1, an internal combustion engine is known having a crankcase ventilation system having a pressure regulating valve that is situated between a crankcase and an intake pipe of the internal combustion engine, and is connected to the intake pipe through two ventilation ducts, of which the one opens into the intake pipe before a compressor of an exhaust gas turbocharger and the other opens into the intake pipe behind a throttle valve. Each of the two ventilation ducts contains a check valve, both of which are integrated into duct connections of the pressure regulating valve. Here, a disadvantage is that a malfunction or failure of the crankcase ventilation system is not easily recognizable.

Because a defect in the crankcase ventilation system often causes emissions to the environment of uncombusted hydrocarbons that are dangerous to health, in various countries there are already regulations specifying that the proper functioning of the crankcase ventilation system has to be monitored in order to enable immediate recognition and correction of the escape of uncombusted hydrocarbons as a result of functional disturbances.

From DE 10 2009 008 831 A1, an internal combustion engine and a method for monitoring a crankcase ventilation system of the internal combustion engine are known. The method is based on the idea of situating the check valves known from DE 102 49 720 A1 away from the pressure regulating valve, at the system limits of the crankcase ventilation system, i.e. directly on the intake air duct. This is intended to make it possible to use a pressure sensor to monitor leakage between the crankcase ventilation system on the one hand and the intake air duct on the other hand without additional measures, the pressure sensor being situated in the intake air duct behind the throttle valve, and being used to determine a cylinder filling level, which sensor however here is also intended to be used to monitor the introduction of the ventilation gases from the crankcase ventilation system into the intake air duct in intake operation and in charge pressure operation. In this method, it is regarded as disadvantageous that, due to the acquisition of only one pressure value in the intake air duct, the method does not always provide reliable information concerning the functioning of the crankcase ventilation device, so that the desired monitoring is not reliably ensured.

Therefore, the object of the present invention is to create an internal combustion engine and a method as indicated above that enable monitoring of the functioning of the crankcase ventilation device of the internal combustion engine in a technically relatively simple manner, nonetheless having a high degree of reliability.

### SUMMARY OF THE INVENTION

The solution of the first part of the object, relating to the internal combustion engine, may be achieved according to the present invention by an internal combustion engine of the type indicated above that is characterized in that means are provided for measuring a pressure difference between the pressure in the crankcase or in the ventilation duct upstream from the crankcase pressure regulating valve on the one hand, and the pressure in the ventilation duct downstream from the crankcase pressure regulating valve on the other hand, and that an evaluation unit is provided by which the measured pressure difference can be evaluated to determine proper or improper functioning of the crankcase ventilation device, and a corresponding item of information can be outputted.

In the internal combustion engine according to the present invention, using advantageously simple technical means reliable information can be obtained as to whether the crankcase ventilation device of the internal combustion engine is operating properly or not. It has been discovered that the values of the pressure difference that occur during proper functioning and operation of the crankcase ventilation device differ recognizably from the values of the pressure difference that occur during improper functioning and operation of the crankcase ventilation device, in particular when the ventilation duct or one of the ventilation duct branches has an undesired connection to the ambient air, which is the error situation most frequently encountered in practice. Leakage of environmentally harmful pollutants from the ventilation device to the surrounding environment is recognized early in this way, and correction of the damage can be initiated correspondingly quickly.

In a first further embodiment of the internal combustion engine, it is provided that the means for measuring the pressure difference between the pressure in the crankcase or in the ventilation duct upstream from the crankcase pressure regulating valve on the one hand and the pressure in the ventilation duct downstream from the crankcase pressure regulating valve on the other hand is a difference pressure sensor that is connected with a first inlet to the crankcase, or, upstream from the crankcase pressure regulating valve, to the ventilation duct, and is connected with a second inlet, downstream from the crankcase pressure regulating valve, to the ventilation duct, and that has an electrical output connected to the evaluation unit. In this embodiment of the internal combustion engine, only a single sensor is required to acquire the pressure difference, thus contributing to a simple and low-cost manufacture and installation. Difference pressure sensors that can be used for the purpose provided here are commercially available and therefore do not need to be described in detail here. It is essential that the difference pressure sensor offers sufficient resolution at the pressures occurring at the measurement locations, and that it can reliably withstand the conditions of use at the internal combustion engine, with the mechanical, thermal, and chemical stresses that occur there.

In an alternative embodiment of the internal combustion engine, it is provided that the means for measuring the pressure difference between the pressure in the crankcase or in the ventilation duct upstream from the crankcase pressure regulating valve on the one hand and the pressure in the ventilating duct downstream from the crankcase pressure regulating valve on the other hand is formed by two pressure sensors, a first pressure sensor being connected to the crankcase or, upstream from the crankcase pressure regulating valve, to the ventilation duct, and a second pressure sensor being connected downstream from the crankcase pressure regulating valve to the ventilation duct, each pressure sensor having an electrical output connected to the evaluation unit. In this embodiment of the present invention, first two pressure values are measured and are transmitted in the form of electrical measurement signals to the evaluation unit, in which the pressure difference can then be calculated from the two pressure values, in order then to evaluate this difference for the presence of proper or improper functioning of the crankcase ventilation device.

For example, the pressure difference sensor or sensors can each have a membrane that can be shifted into its position as a function of the difference pressure or of the pressure, and whose position can be determined by a respectively allocated position acquisition device and can be outputted as a measurement signal to the evaluation unit via the electrical output. Suitable position acquisition devices are known and can be formed for example by a Hall effect sensor or by a piezoeffect sensor, or by a capacitive or inductive sensor.

In internal combustion engines in whose ventilation duct branches the check valves are situated immediately at the connection points to the intake air duct, when operating and environmental conditions are unfavorable there is the danger of freezing of the check valves, causing them to no longer perform their intended function, and causing disturbances in the crankcase ventilation. In order to exclude this risk, or at least to reduce it, the present invention proposes that in each case the check valve is situated in the ventilation duct branches immediately downstream from the point at which the ventilation duct is divided into the two ventilation duct branches. Through this configuration of the check valves, they are no longer subject to the effect of the cold intake air flow in the intake air duct, which largely prevents freezing of the check valves.

In order to prevent parts of the lubricant oil of the internal combustion engine from undesirably moving from its crankcase along with the crankcase ventilation gas into the intake air duct of the internal combustion engine, it is provided that an oil separator for separating oil out from the crankcase ventilation gas is allocated to the crankcase pressure regulating valve, the oil separator being situated upstream from the crankcase pressure regulating valve. In addition, due to the indicated series connection with the oil separator situated upstream from the crankcase pressure regulating valve, contamination of the crankcase pressure regulating valve by oil from the crankcase ventilation gas is avoided, which promotes the reliability of the functioning of the crankcase pressure regulating valve. Oil separators suitable for such use are known in various embodiments and therefore need not be described here in detail.

If, as described above, an oil separator is connected before the crankcase pressure regulating valve, then the means for measuring the pressure difference are usefully connected to the ventilation duct on the one hand upstream from the oil separator and on the other hand downstream from the crankcase pressure regulating valve. The measured pressure difference is then the pressure difference that occurs over the series circuit of oil separator and crankcase pressure regulating valve, which can be evaluated in the same way as the pressure difference occurring only at the crankcase pressure regulating valve with regard to determining proper or improper functioning of the crankcase ventilation device.

In order to enable the crankcase ventilation device to be attached as simply as possible to the rest of the internal combustion engine during its manufacture, and to protect the parts of the crankcase ventilation device from harmful external influences during operation, it is proposed that a segment of the ventilating duct having the crankcase pressure regulating valve and the oil separator, the means for measuring the pressure difference, and the segments of the ventilating duct branches containing the check valves be housed in a common housing.

In order to exclude any risk of freezing of parts of the crankcase ventilation device, in particular the check valves, usefully the interior of the common housing, with the parts of the crankcase ventilation device situated therein, can be heated by waste heat from the internal combustion engine, and/or by a separate heating device. For example, the housing can be capable of being connected to a cylinder head hood, or can be fashioned as part of the cylinder head hood, heating then being enabled by the heat radiated by the cylinder head of the internal combustion engine. Alternatively or in addition, the separate heating device can be provided, which can be operated for example with electrical energy or with energy from the cooling water of the internal combustion engine. For example, an electrical heating device can be switched on during a cold start phase of the internal combustion engine, until the internal combustion engine itself emits sufficient heat to the crankcase ventilation device.

So that a separate additional evaluation unit does not have to be manufactured and installed for the crankcase ventilation device, preferably the evaluation unit is an electronic engine control module that is allocated to the internal combustion engine and is already present in current internal combustion engines, and that can perform, after corresponding programming, the evaluation of the measurement values of the difference pressure sensor or sensors of the crankcase ventilation device. Because the engine control module acts immediately on the functions of the internal combustion engine, when improper functioning of the crankcase ventilation device is determined by the engine control module a corresponding warning signal can be outputted to an operator of the internal combustion engine, and/or a starting of the internal combustion engine can be prevented when it is next set into operation.

The second part of the object indicated above, relating to the method, may be achieved according to the present invention by a method of the type named above that is characterized in that a pressure difference between the pressure in the crankcase or in the ventilation duct upstream from the crankcase pressure regulating valve on the one hand and the pressure in the ventilating duct downstream on the other hand is measured, and that the measured pressure difference is evaluated for proper or improper functioning of the crankcase ventilation device, and a corresponding item of information is outputted. With this method, the crankcase ventilation device of the internal combustion engine can reliably be monitored for proper functioning.

In a further embodiment of the method according to the present invention, it is provided that current operating parameters of the internal combustion engine are acquired and that the measured pressure difference is compared to stored pressure difference target values that are a function of operating parameters, and that, when there are deviations of the measured pressure difference from the pressure difference target value that are less than a specifiable threshold value, the functioning of the crankcase ventilation device is determined as being correct, and when there are deviations of the measured pressure difference from the pressure difference target value that are greater than a specifiable threshold value the functioning of the crankcase ventilation device is determined as being incorrect. In this embodiment of the method, in different or arbitrary operating states of the internal combustion engine the desired monitoring of the functioning of the crankcase ventilation device is therefore ensured. The acquisition of the current operating parameters of the internal combustion engine is already standard in today's internal combustion engines, so that there is no additional outlay for this purpose. Rather, the current operating parameters, which are already acquired anyway, are also used for the monitoring of the functioning of the crankcase ventilation device.

Depending on legal requirements, when improper functioning of the crankcase ventilation device has been determined a corresponding warning signal can be outputted to an operator of the internal combustion engine, and/or a starting of the internal combustion engine can be prevented.

The crankcase ventilation device described above, having the means for acquiring the pressure difference, can in principle also be used with internal combustion engines that do not have a compressor in their intake air duct. In this case, the ventilation duct is not branched into two ventilation duct branches, but rather is guided as a single ventilation duct to the intake air duct, and is usefully connected downstream from the throttle valve situated in the intake air duct.

Additional aspects, embodiments, and details of the invention, all of which may be combinable in any manner, are set forth in the following detailed description of the invention.

### DETAILED DESCRIPTION OF THE DRAWINGS

In the following, exemplary embodiments of the present invention are explained on the basis of the following drawing figures, in which:

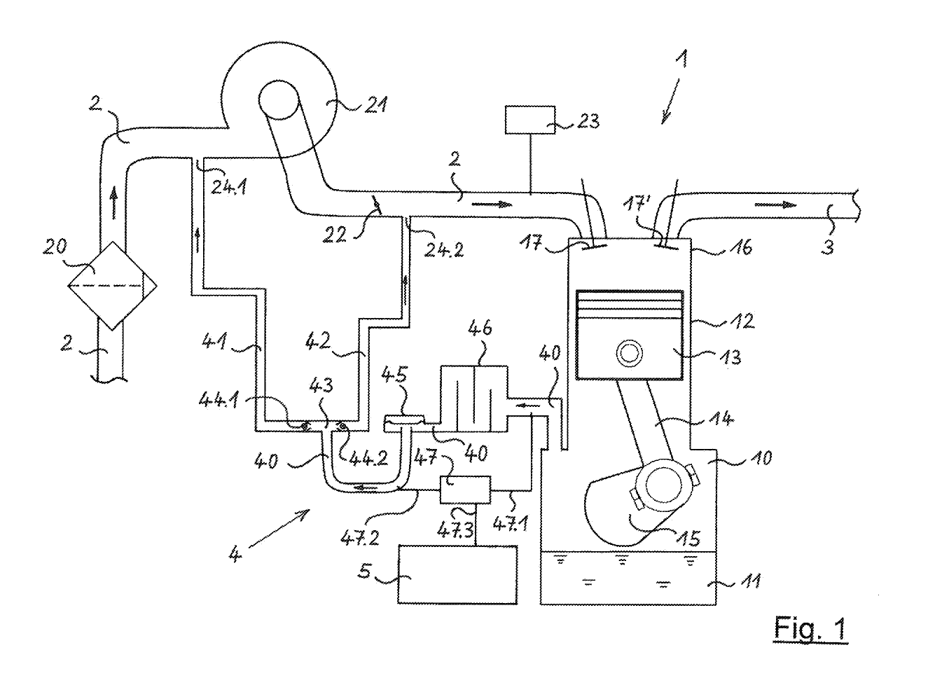

FIG. 1 shows an internal combustion engine having a crankcase ventilation device, in a schematic representation, and;

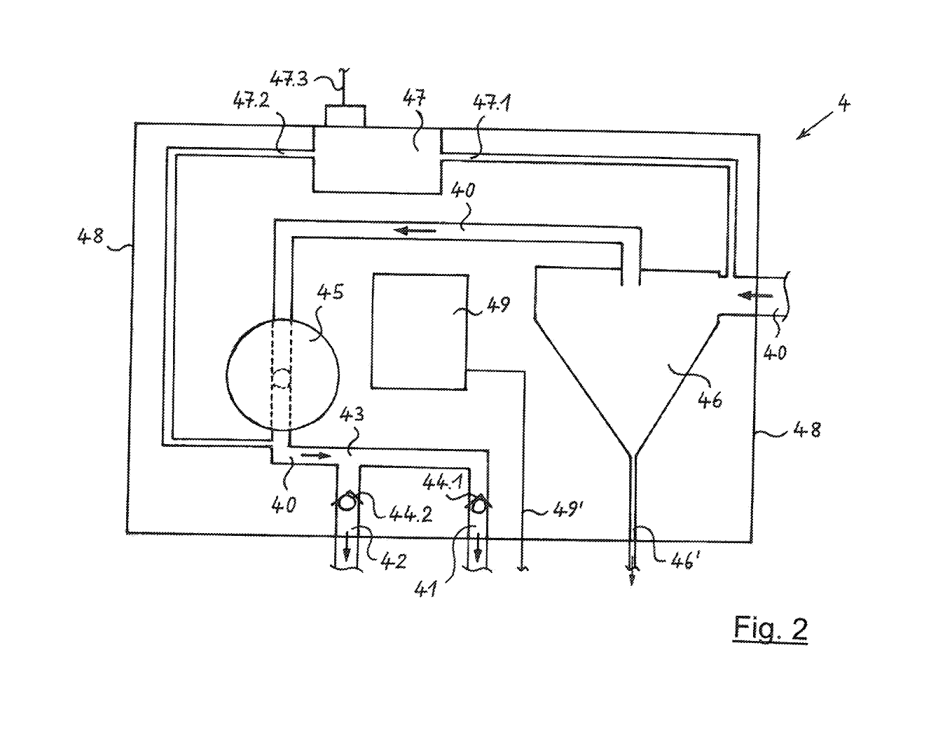

FIG. 2 shows the crankcase ventilation device in a modified embodiment, also in a schematic representation.

### DETAILED DESCRIPTION OF THE INVENTION

FIG. 1 shows an internal combustion engine 1 having a crankcase ventilation device 4 in a purely schematic representation. At the right in FIG. 1, a crankcase 10 of internal combustion engine 1 can be seen, whose lower part forms an oil sump 11 for the lubricant oil of internal combustion engine 1. In crankcase 10, crankshaft 15 is mounted, from which there goes out a connecting rod 14 connected at its upper end to a piston 13. Piston 13 is guided so as to be movable in the axial direction in a cylinder 12 of internal combustion engine 1. Above piston 13 there is situated a cylinder head 16 having an inlet valve 17 and outlet valve 17′.

At the left and at the top in FIG. 1, an intake air duct 2 is visible that leads to inlet valve 17 via an air filter 20 and a compressor 21 of a turbocharger or compressor. A throttle valve 22 is situated in intake air duct 2 between compressor 21 and inlet valve 17. An air mass sensor 23 is connected to the segment of intake air duct 2 between throttle valve 22 and inlet valve 17.

An exhaust gas line 13 that leads to a muffler (not shown) goes out from outlet valve 17′ of internal combustion engine 1.

In FIG. 1, to the left of internal combustion engine 1 crankcase ventilation device 4 and its parts are visible. A ventilation duct 40 is connected to crankcase 10 of internal combustion engine 1, said duct first leading into an oil separator 46, realized here as an impact and deflection separator. An outlet of oil separator 46 is connected, via a short further segment of ventilation duct 40, to the inlet of a crankcase pressure regulating valve 45. A further segment of ventilation duct 40 goes out from an outlet of crankcase pressure regulating valve 45.

Ventilation duct 40 then branches, at a branching point 43, into two ventilation duct branches 41 and 42. First ventilation duct branch 41 leads to a connecting point 24.1 of intake air duct 2 between air filter 20 and compressor 21. Second ventilation duct branch 42 leads to a connecting point 24.2 of intake air duct 2 between throttle valve 22 and inlet valve 17 of internal combustion engine 1. Immediately downstream from branching point 43, in each ventilation duct branch 41, 42 there is situated a respective check valve 44.1, 44.2.

During operation of internal combustion engine 1, crankcase ventilation gas flows from crankcase 10 through ventilation duct 40, first into oil separator 40, in which, in a known manner, oil particles carried along with the crankcase ventilation gas are separated in the form of oil mist and/or oil droplets. Via an oil return line (not shown), the separated oil is carried back into crankcase 10.

The crankcase ventilation gas, from which the oil has been removed, then flows through crankcase pressure regulating valve 45 and subsequently reaches branching point 43. Crankcase pressure regulating valve 45 ensures that in crankcase 10 a pressure is maintained that is within specifiable boundary values, standardly somewhat below the ambient air pressure.

Depending on the operating state of internal combustion engine 1, the crankcase ventilation gas flows from branching point 43 into intake air duct 2, either through first ventilation duct branch 41 or through second ventilation duct branch 42, and is supplied through the intake air duct, together with the combustion air, to cylinder 12 of internal combustion engine 1 via inlet valve 17. Here, the flow of the crankcase ventilation gas through first ventilation duct branch 41 always takes place when compressor 21 is operating, and in the segment of intake air duct 2 before compressor 21 a lower pressure therefore prevails than in the segment of intake air duct 2 behind compressor 21. When compressor 21 is not operating, for example during no-load operation or low output of internal combustion engine 1, then the flow of the crankcase ventilation gas takes place from branching point 43 through second ventilation duct branch 42 into intake air duct 2, because in this case in the segment of intake air duct 2 between throttle valve 22 and inlet valve 17 a lower pressure prevails than in the segment of intake air duct 2 before compressor 21.

Up to this point, as previously described, the ventilation device 4 corresponds to known devices of this type.

What is new in ventilation device 4 shown in FIG. 1 is that this device has means 47 for acquiring a pressure difference between the pressure in ventilation duct 40 before oil separator 46 and the pressure in ventilation duct 40 behind crankcase pressure regulating valve 45. In the depicted example, means 47 is a difference pressure sensor whose first measurement input 47.1 is connected to the segment of ventilation duct 40 between crankcase 10 and oil separator 46, and whose second measurement input 47.2 is connected to the segment of ventilation duct 40 between crankcase pressure regulating valve 45 and branching point 43. The pressure difference determined in the difference pressure sensor is forwarded via an electrical output 47.3, as an electrical measurement signal, to an electronic evaluation unit 5.

Instead of the one difference pressure sensor, as means 47 it is also possible for two individual pressure sensors to be used, of which the one is connected to the segment of ventilation duct between crankcase 10 and oil separator 46 and the other is connected to the segment of ventilation duct 40 between crankcase pressure regulating valve 45 and branching point 43. In this embodiment, each pressure sensor then forwards, via its electrical output, the respectively determined pressure values, as an electric measurement signal, to evaluation unit 5, which then calculates the pressure difference from these values.

Evaluation unit 5 compares the determined or calculated value of the measured pressure difference with stored pressure difference target values. If the value of the measured pressure difference deviates from the stored pressure difference target value by less than a specifiable threshold value, this is a criterion indicating correct functioning of crankcase ventilation device 4. If, in contrast, the value of the measured pressure difference deviates from the stored pressure difference target value by more than a specifiable threshold value, this is a criterion indicating incorrect functioning of crankcase ventilation device 4. Improper functioning of crankcase ventilation device 4 occurs in practice in particular when ventilation duct 40, or one of the ventilation duct branches 41, 42, or one of the components situated in the course thereof, has an undesired flow connection to the open surrounding environment. In this case, evaluation unit 5 provides a corresponding display to an operator of internal combustion engine 1, and/or prevents starting of internal combustion engine 1 when it is next set into operation.

If a monitoring of the functioning of crankcase ventilation device 4 is to take place not only in a single operating state, such as for example no-load operation of internal combustion engine 1, current operating parameters of internal combustion engine 1 are acquired. The pressure difference measured during a current operating state of internal combustion engine 1 is then compared to corresponding stored pressure difference target values that are a function of operating parameters. The evaluation in evaluation unit 5 then takes place, as described above, in such a manner that when deviations of the measured pressure difference from the pressure difference target value are less than a specifiable threshold value the functioning of crankcase ventilation device 4 is determined as correct, and when deviations of the measured pressure difference from the pressure difference target value are greater than a specifiable threshold value the functioning of crankcase ventilation device 4 is determined as incorrect. In this embodiment of the method, given different or arbitrary operating states of internal combustion engine 1, the desired monitoring of the functioning of crankcase ventilation device 4 is therefore ensured. In today's internal combustion engines 1, the acquisition of the current operating parameters is already standard, so that no additional outlay is required for this. These operating parameters are for example the position of throttle valve 22 in intake air duct 2, the air mass flowing through intake air duct 2 and acquired by air mass sensor 23, and the rotational speed of crankshaft 15 of internal combustion engine 1.

FIG. 2 shows crankcase ventilation device 4 in a modified embodiment, also in a schematic representation. Characteristic of the embodiment shown here is that the parts of crankcase housing ventilation device 4 are combined and housed as a unit in a common housing 48. Housing 48, with the parts situated therein, can then advantageously be pre-manufactured and assembled as a compact unit on an associated internal combustion engine 1.

In FIG. 2, at the right in housing 48 oil separator 46 can be seen, realized here as a cyclone separator. The segment of ventilation duct 40 coming from the crankcase of the internal combustion engine opens tangentially into the upper region of oil separator 46. The further segment of ventilation duct 40, leading to crankcase pressure regulating valve 45 situated at the left in housing 48, goes out from the central upper region of oil separator 46. From the lowest point of oil separator 46 there goes out an oil return duct 46′ through which oil separated in oil separator 46 can be supplied back to the crankcase of the internal combustion engine.

Downstream from crankcase pressure regulating valve 45, ventilation line 40 branches, at branching point 43, into the two ventilation duct branches 41 and 42. In each ventilation duct branch 41, 42 there is situated a respective check valve 44.1, 44.2, still inside housing 48.

At the top in housing 48, means 47 is shown in the form of the difference pressure sensor for measuring the pressure difference between the segment of ventilation duct 40 situated upstream from oil separator 46 as first measurement location, and the segment of ventilation duct 40 situated downstream from crankcase pressure regulating valve 45 as second measurement location. The named measurement locations are each connected to one of the measurement inputs 47.1, 47.2 of difference pressure measuring means 47. Via electrical output 47.3, the difference pressure sensor forwards the measured pressure difference, as an electrical signal, to the evaluation unit (not shown in FIG. 2).

In the center of housing 48, here a heating device 49 is situated by which the interior of housing 48 and the parts of crankcase ventilation device 4 situated therein can be brought to a suitable temperature. In the example shown, heating device 49 is an electrical device that can be supplied with electrical energy via a line 49′. Inter alia, heating device 49 ensures that freezing of check valves 44.1, 44.2 is reliably excluded, which significantly increases the reliability of crankcase ventilation device 4 during operation.

When crankcase ventilation device 4 is installed on the associated internal combustion engine, housing 48 only has to be mechanically fastened as a whole, and the necessary flow connections for ventilation duct 40, for ventilation duct branches 41 and 42, and for oil return duct 46′ have to be produced e.g. by plug-on hose ducts or flanged-on pipe ducts, and electrical lines 47.3 and 49′ have to be connected. These steps take little time, ensuring rapid installation.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

### LIST OF REFERENCE CHARACTERS

1 internal combustion engine
10 crankcase
11 oil sump
12 cylinder
13 piston
14 connecting rod
15 crankshaft
16 cylinder head
17 inlet valve
17′ outlet valve
2 intake air duct
20 air filter
21 compressor
22 throttle valve
23 air mass sensor
24.1 point of connection of 41 to 2
24.2 point of connection of 42 to 2
3 exhaust gas line
4 crankcase ventilation device
40 ventilation duct
41 first ventilation duct branch
42 second ventilation duct branch
43 branching point
44.1 check valve in 41
44.2 check valve in 42
45 crankcase pressure regulating valve
46 oil separator
46′ oil return duct
47 difference pressure measuring means
47.1, 47.2 measurement inputs of 47
47.3 electrical output of 47
48 housing
49 heating device
49′ duct
5 evaluation unit

Claimed is:

1. An internal combustion engine comprising:
an intake air duct in which there are situated a compressor of an exhaust gas turbocharger or compressor, and, downstream from the compressor, a throttle valve,
a crankcase ventilation device that has a ventilation duct connected to a crankcase of the internal combustion engine and in which there is situated a crankcase pressure regulating valve, the ventilation duct being divided, downstream from the crankcase pressure regulating valve, into two ventilation duct branches, a first ventilation duct branch being connected to an intake air duct at a point of connection upstream from the compressor, and a second ventilation duct branch being connected to the intake air duct at a point of connection downstream from the throttle valve, and a respective check valve being situated in each ventilation duct branch,
means for measuring a pressure difference between the pressure in the crankcase or in the ventilation duct upstream from the crankcase pressure regulating valve on the one hand and the pressure in the ventilation duct downstream from the crankcase pressure regulating valve on the other hand, and
an evaluation unit by which the measured pressure difference can be evaluated for the presence of a correct or incorrect functioning of the crankcase ventilation device, and a corresponding item of information can be outputted.

2. The internal combustion engine of claim 1, wherein the means for measuring the pressure difference between the pressure in the crankcase or in the ventilation duct upstream from the crankcase pressure regulating valve on the one hand and the pressure in the ventilation duct downstream from the crankcase pressure regulating valve on the other hand is a difference pressure sensor that is connected with a first input to the crankcase, or, upstream from the crankcase pressure regulating valve, to the ventilation duct, and is connected to the ventilation duct with a second input, downstream from the crankcase pressure regulating valve, and that has an electrical output connected to the evaluation unit.

3. The internal combustion engine of claim 1, wherein the means for measuring the pressure difference between the pressure in the crankcase or in the ventilation duct upstream from the crankcase pressure regulating valve on the one hand and the pressure in the ventilation duct downstream from the crankcase pressure regulating valve on the other hand is formed by two pressure sensors, a first pressure sensor being connected to the crankcase or, upstream from the crankcase pressure regulating valve, to the ventilation duct, and a second pressure sensor being connected to the ventilation duct, downstream from the crankcase pressure regulating valve, each pressure sensor having an electrical output connected to the evaluation unit.

4. The internal combustion engine of claim 1, wherein e the check valves are situated in the ventilation duct branches immediately downstream from the branching point of the ventilation duct into the two ventilation duct branches.

5. The internal combustion engine of claim 1, further comprising:
an oil separator for separating oil from the crankcase ventilation gas allocated to the crankcase pressure regulating valve, the oil separator being situated upstream from the crankcase pressure regulating valve.

6. The internal combustion engine of claim 5, wherein the means for measuring the pressure difference is/are connected to the ventilation duct on the one hand upstream from the oil separator and on the other hand downstream from the crankcase pressure regulating valve.

7. The internal combustion engine of claim 5, wherein a segment of the ventilation duct having the crankcase pressure regulating valve and the oil separator, the means for measuring the pressure difference and the segments of the ventilation duct branches containing the check valves are housed in a common housing.

8. The internal combustion engine of claim 7, wherein an interior of the common housing is capable of being heated by waste heat of the internal combustion engine and/or by a separate heating device.

9. The internal combustion engine of claim 1, wherein the evaluation unit comprises an electronic engine control module allocated to the internal combustion engine, by which, when the evaluation unit has been determined that the crankcase ventilation device is not functioning correctly, a corresponding warning signal can be outputted to an operator of the internal combustion engine and/or a starting of the internal combustion engine can be prevented.

10. A method for monitoring a crankcase ventilation device of an internal combustion engine having an intake air duct in which there is situated a compressor of an exhaust gas turbocharger or compressor, and, downstream from the compressor, a throttle valve, the crankcase ventilation device having a ventilation duct connected to the crankcase of the internal combustion engine, in which there is situated a crankcase pressure regulating valve, the ventilation duct being divided, downstream from the crankcase pressure regulating valve, into two ventilation duct branches, a first ventilation duct branch being connected to the intake air duct at a point of connection upstream from the compressor, and a second ventilation duct branch being connected to the intake air duct at a point of connection downstream from the throttle valve, and a respective check valve being situated in each ventilation duct branch, wherein the method comprises:
measuring a pressure difference between the pressure in the crankcase or in the ventilation duct upstream from the crankcase pressure regulating valve on the one hand and the pressure in the ventilation duct downstream from the crankcase pressure regulating valve on the other hand,
evaluating the measured pressure difference for the presence of a correct or incorrect functioning of the crankcase ventilation device, and,
outputting a corresponding item of information.

11. The method of claim 10, further comprising:
acquiring current operating parameters of the internal combustion engine, and
comparing the measured pressure difference to stored pressure difference target values that are a function of the current operating parameters, wherein when there are deviations of the measured pressure difference from the pressure difference target value that are less than a specifiable threshold value, the functioning of the crankcase ventilation device is determined as correct, and when there are deviations of the measured pressure difference from the pressure difference target value that are greater than a specifiable threshold value, the functioning of the crankcase ventilation device is determined as incorrect.

12. The method of claim 10, further comprising:
outputting a corresponding warning signal is outputted to an operator of the internal combustion engine and/or a starting of the internal combustion engine is prevented, when an incorrect functioning of the crankcase ventilation device has been determined.
